(19) United States
(12) Patent Application Publication
(10) Pub. No.: US 2012/0092112 A1
(43) Pub. Date: Apr. 19, 2012

(54) TOROID WITH CHANNELS AND CIRCUIT ELEMENT AND MODULAR JACK WITH SAME

(75) Inventors: Timothy R. McClelland, Bolingbrook, IL (US); Johnny Chen, Danville, CA (US)

(73) Assignee: Molex Incorporated, Lisle, IL (US)

(21) Appl. No.: 13/264,597

(22) PCT Filed: Apr. 14, 2010
(86) PCT No.: PCT/US10/31027

§ 371 Date: Jan. 6, 2012

Related U.S. Application Data
(60) Provisional application No. 61/170,221, filed on Apr. 17, 2009.

(51) Int. Cl. H01F 27/02; H01F 27/28; H01F 27/24

(52) U.S. Cl. 336/90; 336/233; 336/221

(57) ABSTRACT

A circuit element is provided for mounting in an electrical connector. The circuit element includes a one-piece toroidal core made of a sintered, ferrite material. The core has a central bore therein defining an inner surface, an outer surface and oppositely facing top and bottom surfaces, and a plurality of equally spaced apart longitudinal channels formed in one of the top, bottom, inner and outer surfaces. A plurality of wires are twisted together in a uniform, repeating pattern to define a group of twisted wires. The group of twisted wires extends through the central bore and is wrapped around the core to define a plurality of uniformly spaced longitudinal turns with a portion of each turn being positioned in one of the channels.

### RELATED APPLICATIONS

This application claims priority to U.S. Provisional Application No. 61/170,221, filed Apr. 17, 2009, which is incorporated herein by referenced in its entirety.

### BACKGROUND OF THE INVENTION

The present invention relates generally to modular telecommunications jacks and, more particularly, to a high speed modular jack having improved circuitry therein.

Modular jack (“modjack”) receptacle connectors mounted to printed circuit boards (“PCBs”) are well known in the telecommunications industry. These connectors are typically used for electrical connection between two electrical communication devices. With ever-increasing operating frequencies of data and communication systems and an increased density of information to be transmitted, the electrical characteristics of such connectors are of increasing importance. In particular, it is especially desirable that these modjack connectors do not negatively affect the signals transmitted and that no additional interference is introduced into the system. Based on these requirements, various proposals have been made in order to potentially minimize negative influences of modjack connectors used with communication or transmission links.

When used as Ethernet connectors, modjacks generally receive an input signal from one electrical device and then communicate a corresponding output signal to a second device coupled thereto. Magnetic circuitry can be used to perform filtering of the signals during transfer of the signals from the first device to the second and typically use either a transformer and a single or a dual channel ferrite choke. Such chokes typically are toroidal magnetic ferrite common mode chokes and are used to reduce the amount of unwanted common mode noise in differential signaling applications. Modjacks having such magnetic circuitry are typically referred to in the trade as magnetic jacks.

For the elimination of in-phase interference signal noise components, U.S. Pat. No. 5,015,204 describes the use of a common-mode choke arranged in a connector housing around which the contact leads of a RJ-45 modjack connector are integrally wound. In this design, the common-mode choke takes up a substantial portion of the connector housing even though only two signal-conducting leads are used. Furthermore, the respective leads need a certain rigidity to provide resilient forces to continuously facilitate a secure contact with the associated modular plug connector. Unfortunately, this makes for difficult manufacturing conditions, especially when the rigid wires have to be wound around the conductive core of the choke coil and the entire assembly placed within the modjack housing.

Typical magnetic jacks utilized a dielectric housing with conductive metal terminals therein for connecting to conductive metal terminals of a mating plug connector. The housing and terminals of the magnetic jacks are configured so that magnetic subassemblies may be inserted therein that are operatively connected to the terminals of the magnetic jack. These magnetics typically utilize a toroid-shaped magnetic core having a plurality of wires wound around the core in order to create a transformer and/or a choke.

As system speeds have increased, increasing the speed of signals that pass through the magnetic jacks has become a significant challenge due to difficulties in maintaining the consistency of the magnetics. The significance of the inconsistencies depends on the speeds at which the magnetic jacks are expected to perform. Magnetic cores that operate within a predetermined range of electrical tolerances at one signalling frequency may have enough electrical inconsistencies so as to be out of tolerance or inoperable at higher signaling frequencies.

Furthermore, even if the wound magnetic subassemblies are precisely manufactured, such subassemblies must also be mounted to housing during the manufacturing process. Given the small size of the magnetics and the connector housings, there is a potential for the magnetics to be damaged or to be become out of specification during installation. In some instances and depending on the speed of the signals passing through the magnetic jack, it may be possible to manually rework the magnetics so that the magnetic jack will operate effectively. In other instances, the magnetic jack may be beyond repair and must be discarded as scrap. Accordingly, in one instance additional labor is required to create an operative jack. In the other, the magnetic jack would be deemed defective. Both of these scenarios substantially increase the cost of manufacturing the magnetic jacks. According, improvements to the design of a magnetic jack would be appreciated by certain individuals.

### SUMMARY OF THE INVENTION

Accordingly, a toroidal circuit element is provided that includes a one-piece toroidal core made of a magnetically permeable material. The core has a central bore therein defining an inner surface, an outer surface and oppositely facing top and bottom surfaces. A plurality of equally spaced apart longitudinal channels are formed in one of the top, bottom and outer surfaces. The toroid can used to provide a circuit element in an electrical connector. The circuit element could include the one-piece toroidal core made of a sintered, ferrite material. The core has a central bore therein defining an inner surface, an outer surface and oppositely facing top and bottom surfaces, and a plurality of equally spaced apart longitudinal channels formed in one of the top, bottom and outer surfaces. A plurality of wires are twisted together in a uniform, repeating pattern to define a group of twisted wires. The group of twisted wires extends through the central bore and is wrapped around the core to define a plurality of uniformly spaced longitudinal turns with a portion of each turn being positioned in one of the channels. In an embodiment, a modular jack may be provided that includes an insulative housing for receiving a mating plug. The housing can include a cavity therein that can receive the circuit element so as to allow for receiving a circuit element to condition signals passing through the jack and a plurality of terminals operatively connected to the magnetics and configured to engage contacts of a corresponding mating plug. Thus, certain aspects of the above-described problems encountered by conventional magnetic jacks can be addressed by providing a structure for maintaining consistent performance of the circuit elements within the magnetic jacks.

### BRIEF DESCRIPTION OF THE DRAWINGS

Various other objects, features and attendant advantages of the disclosure will become more fully appreciated as the same becomes better understood when considered in conjunction with the accompanying drawings, in which like reference characters designate the same or similar parts throughout the several views in which:

FIG. 1 is a front perspective view of an embodiment of a magnetic jack;

FIG. 2 is a partially exploded view of the magnetic jack of FIG. 1 with the outer shielding removed;

FIG. 3 is a partially exploded rear perspective view of the magnetic jack housing of FIG. 2 with the internal modules in various stages of insertion therein;

FIG. 4 is a rear perspective view of a single internal module;

FIG. 5 is an exploded view of the internal module of FIG. 4;

FIG. 6 is perspective view of one of the component housings of FIG. 5 prior to insertion of the noise reduction components therein and with the windings removed for clarity;

FIG. 7 is a perspective view identical to that of FIG. 6 with the noise reduction components inserted therein and with the windings removed for clarity;

FIG. 8 is a perspective view of an embodiment of a transformer toroid;

FIG. 9 is a top plan view of the transformer toroid of FIG. 8;

FIG. 10 is a side elevational view if the transformer toroid of FIG. 8;

FIG. 11 is a perspective view of an embodiment of a transformer toroid;

FIG. 12 is a top plan view of the transformer toroid of FIG. 11;

FIG. 13 is a sectioned perspective view of the transformer toroid of FIG. 11;

FIG. 14 is a cross-sectional view of the transformer toroid taken generally along line 14-14 of FIG. 12;

FIG. 15 is a side elevational view of the twisted wires used with the noise reduction components of the disclosed embodiments;

FIG. 16 is a perspective view of a transformer toroid of FIG. 8 with only the central winding section wound thereon;

FIG. 17 is a side elevational view of a two transformer and choke subassembly;

FIG. 18 is a side elevational view of the two transformer and choke subassembly of FIG. 17 inserted into a receptacle in the component housing;

FIG. 19 is a front perspective view of an embodiment of a single port magnetic jack;

FIG. 20 is a partially exploded view of the magnetic jack of FIG. 19 with the outer shielding removed;

FIG. 21 is a partially exploded front perspective view of the magnetic jack housing of FIG. 19 with the internal module removed therefrom;

FIG. 22 is a front perspective view of the internal module;

FIG. 23 is an exploded view of the internal module of FIG. 22; and

FIG. 24 is perspective view of the component housing of FIG. 23 prior to insertion of the noise reduction components therein and with the windings removed for clarity.

### DETAILED DESCRIPTION OF THE PREFERRED EMBODIMENTS

The following description is intended to convey the operation of the depicted exemplary embodiments to those skilled in the art. It will be appreciated that this description is intended to aid the reader, not to limit the invention. As such, references to particular features are merely intended to describe the feature, not to imply that every embodiment must have each of the described characteristic. Therefore, unless otherwise noted, features disclosed herein may be combined together to form additional combinations that were not otherwise shown for purposes of brevity.

As noted above, it is generally desirable to minimize electrical inconsistencies in the magnetic properties of a magnetic jack. It has been determined that inconsistent spacing in the windings results in electrical inconsistencies within a particular wound core such as differences in capacitance between adjacent windings together with differences in inductance from one winding to the next. In addition, inconsistencies from one wound core to the next will also typically exist and contribute to inconsistent performance between wound cores. In particular, when winding the wires around the toroid-shaped core, it is desirable to maintain equal spacing between the windings. However, since the toroid-shaped cores are very small, as are the wires wound therearound, the winding operation is typically performed by hand and thus the spacing is typically inconsistent to some degree. It has been determined that relatively minor inconsistency can have a significant impact on the performance of the magnetics as a 0.5 pF variation in the performance of the transformer core can cause the magnetics to be out of tolerance.

In addition, since it is desirable to minimize the size of the magnetic jacks, the housing is generally small and thus the space into which the wound magnetic subassemblies are positioned in is also small. In an embodiment where the magnetic subassembly is placed into a cavity in the housing, insertion of the wound magnetic subassembly into its respective receptacle may cause the wound wires on the outer surfaces of the toroid-shaped cores to contact or snag on the edges of the receptacle into which the subassembly is being inserted; thus changing the spacing between the windings and potentially even damaging the windings. Thus, installation of the magnetics has the potential to negatively impact the electrical performance of the wound magnetic subassembly. As will be discussed below, one method to help compensate for movement of the windings is to provide channels in the core to help retain the winding in its desired position. The channels may even have sufficient depth to allow the windings to be completely protected by the channel.

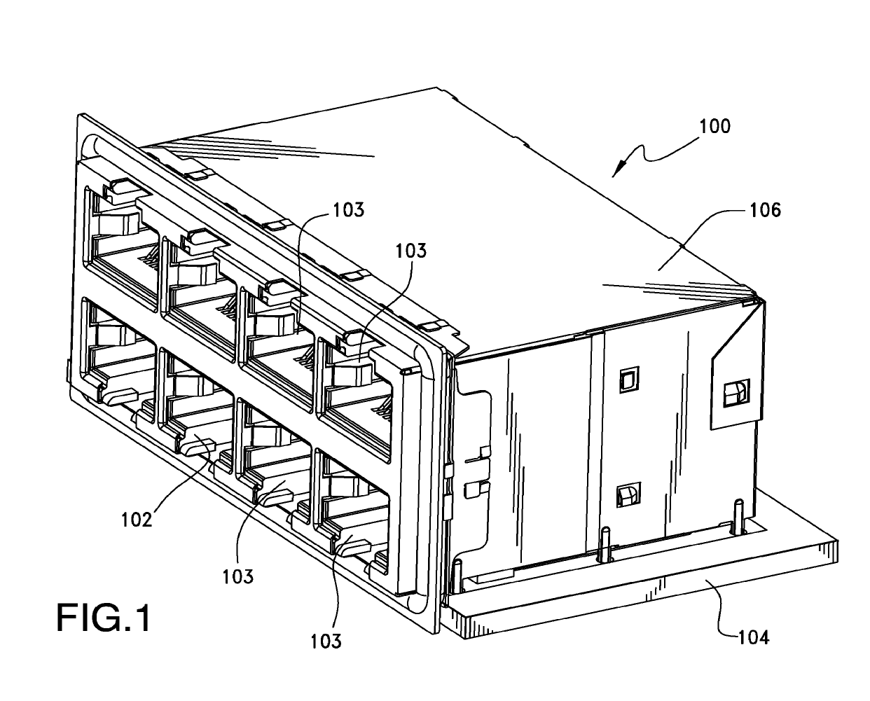

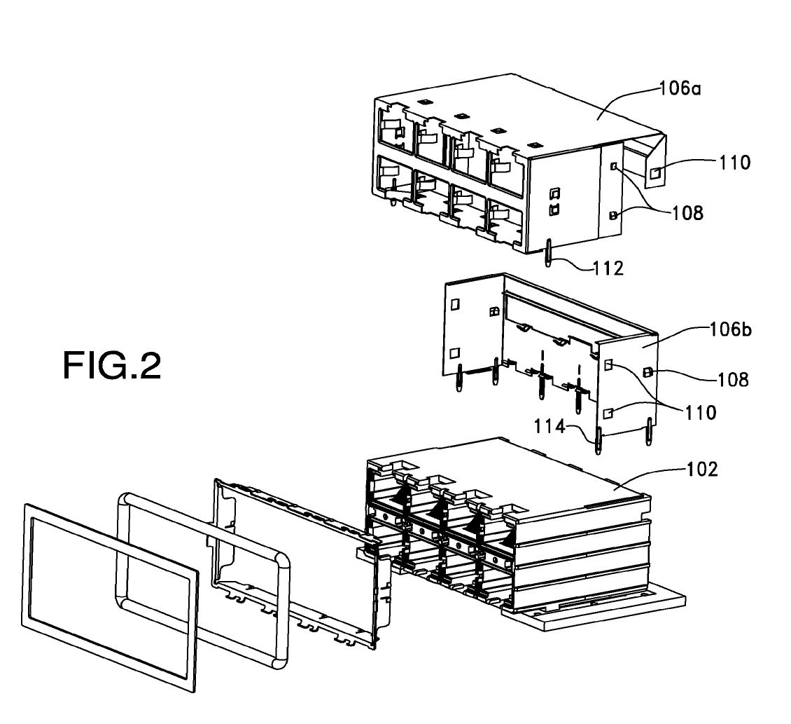

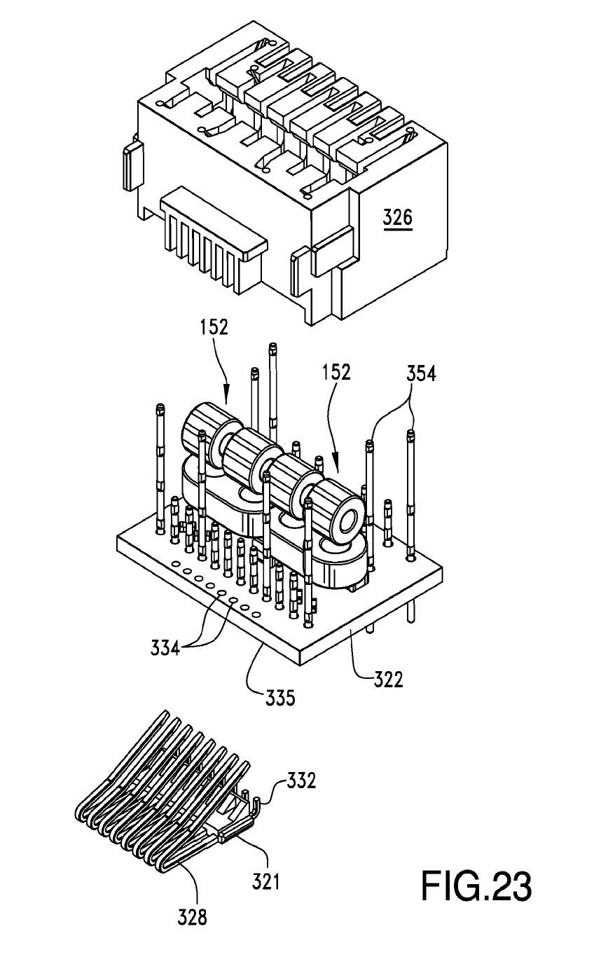

FIGS. 1-2 illustrate the front side of an exemplary embodiment of modular jack. As shown, magnetic jack 100 is a multiple input, stacked jack for receiving multiple Ethernet or RJ-45 type of plugs (not shown). The magnetic jack 100 includes a housing 102 made of an insulating material such as a synthetic resin (for example, PBT) and includes front side openings or ports 103 that are configured to receive Ethernet or RJ-45 type jacks (not shown). The magnetic jack 100 is configured to be mounted on circuit board 104. A metal or other conductive shield assembly 106 surrounds the magnetic jack housing 102 for RF and EMI shielding purposes as well as for providing a ground reference. It should be noted that, as shown in FIGS. 23-28, a similar configuration is possible where only a single unit magnetic jack is desired.

In this description, representations of directions such as up, down, left, right, front, rear, and the like, used for explaining the structure and movement of each part of the disclosed embodiment are not absolute, but relative. These representations are appropriate when each part of the disclosed embodiment is in the position shown in the figures. If the position of the disclosed embodiment changes, however, these representations are to be changed according to the change of the position of the disclosed embodiment.

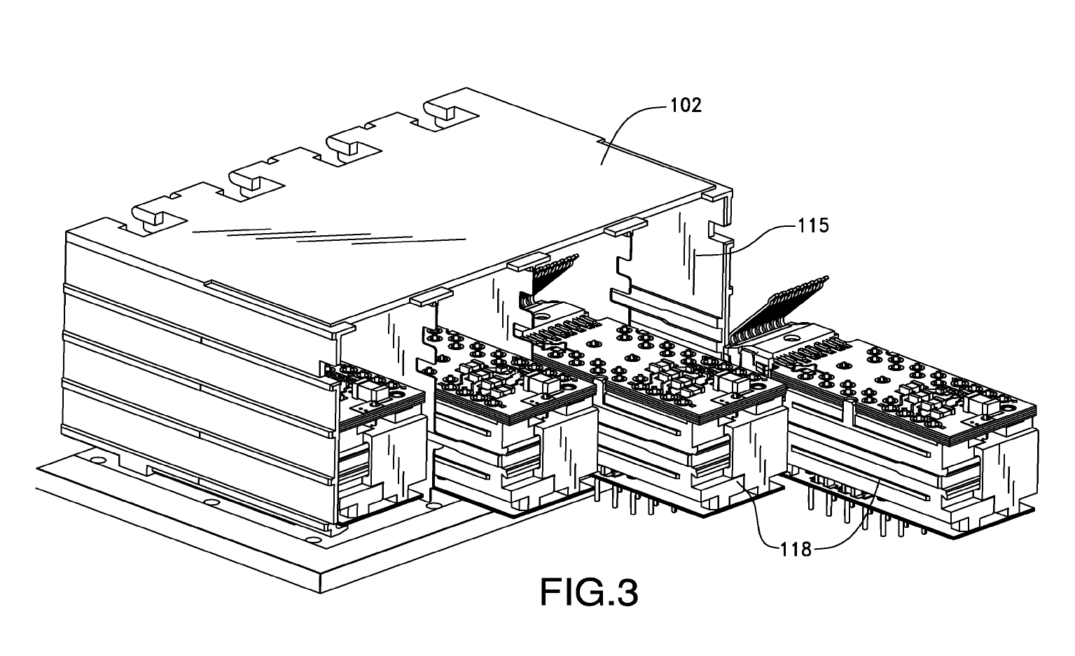

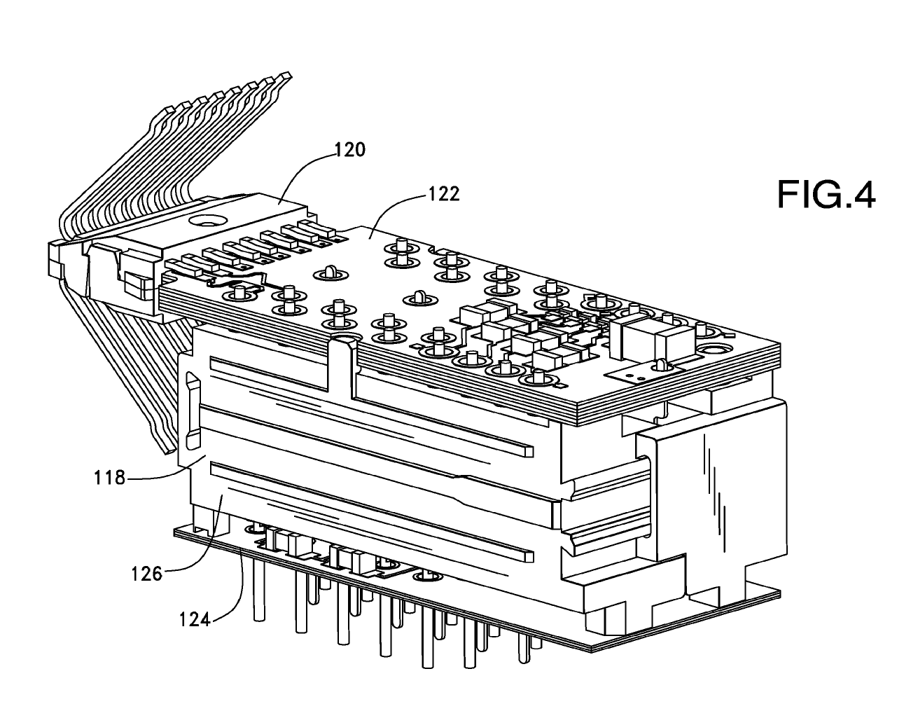

Shield assembly 106 includes a front shield component 106a and a rear shield component 106b. These joinable shield components are formed with interlocking tabs 108 and openings 110 for engaging and securing the components together when the shield assembly 106 is placed into position around the magnetic jack housing 102. Each of the shield components 106a, 106b includes ground pegs 112, 114 that extend into through-holes 116 on the circuit board 104 when placed thereon. As shown in FIG. 3, the rear portion of the magnetic jack housing 102 includes relatively large openings 115 that are sized and shaped to receive internal subassembly modules 118 (FIG. 4). These modules 118 provide the physical contacts for engaging Ethernet plugs and also provide the electrical filtering functionality of the jacks.

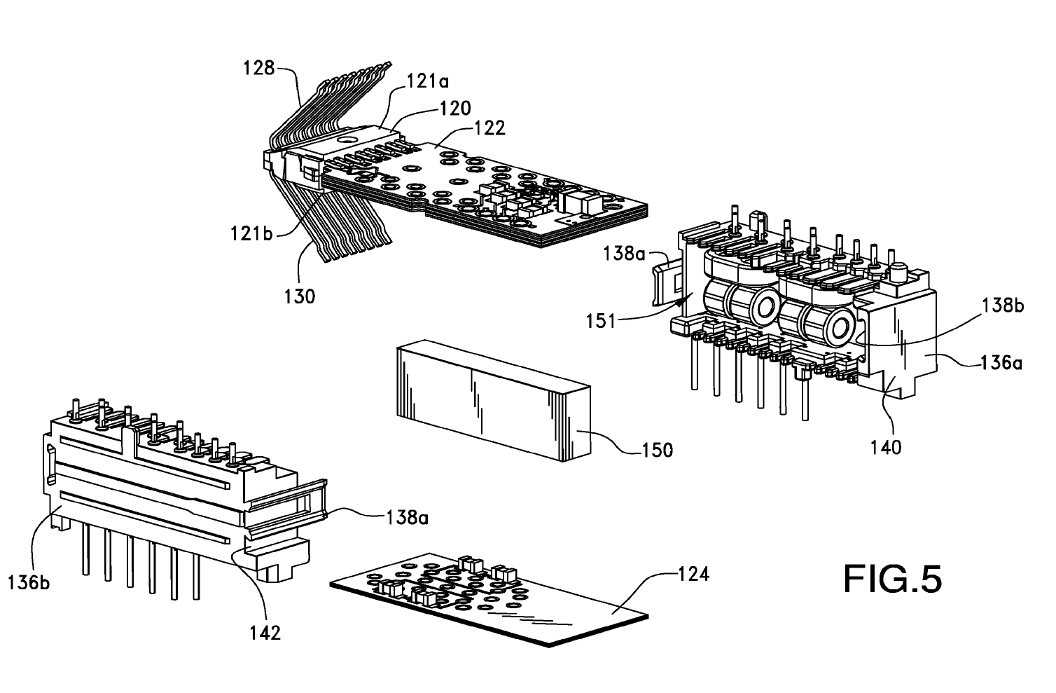

Referring to FIGS. 4 and 5, subassembly module 118 includes a contact module 120 that is electrically connected to a top PCB 122. The top PCB 122 is mounted to a component housing 126, which includes magnetic circuits and filtering components. Bottom PCB 124 is mounted on the bottom of component housing 126. The top and bottom PCBs 122, 124 include the resistors, capacitors and any other components associated with the chokes and transformers located inside the component housing 126, which together comprise the filtering circuitry of the magnetic jack.

Contact module 120 includes a top contact assembly 121a and a bottom contact assembly 121b for providing a stacked jack, or dual jack, functionality. The top contact assembly 121a provides physical and electrical interfaces, including upwardly extending contact terminals 128, for connecting to an Ethernet plug. The bottom contact assembly 121b is physically connected to the top contact assembly 121a and includes downwardly extending electrically conductive contact terminals 130. The contact module 120 is electrically connected to the top PCB 122 through leads 132, which are soldered, or electrically connected by some other means such as welding or conductive adhesive, to a row of PCB pads 134 that are positioned along the top of PCB 122 along one edge thereof and a second, similar row of PCB pads (not shown) on a lower surface of top PCB 122.

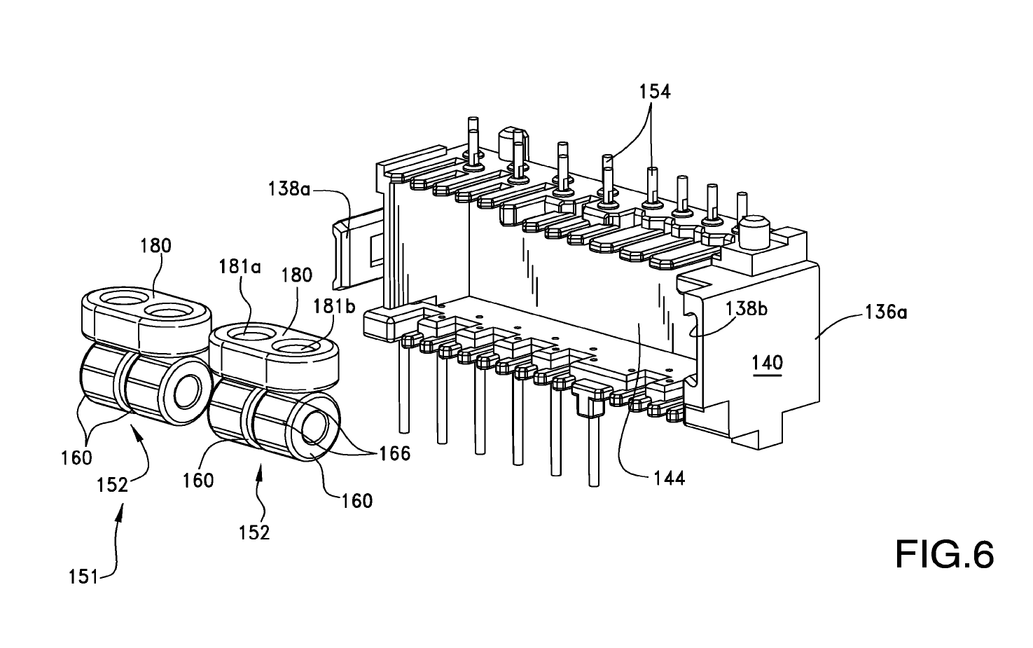

Referring to FIG. 5, component housing 126 is a two piece assembly having a right housing 136a and left housing 136b for holding the magnetics 151. A shock absorbing foam insert 150 for holding and cushioning the magnetics is provided as well. The left and right housings halves 136a, 136b are formed from a synthetic resin such as LCP or other similar material and preferably are physically identical for reducing manufacturing costs and increased ease of assembly. A latch projection 138a extends from the right sidewall 142 of each housing. A latch recess 138b is located in the left sidewall 140 of each housing and lockingly receives latch projection 138a therein. Each housing half 136a, 136b, is formed with a large box-like receptacle or opening 144 (FIG. 6). This receptacle 144 receives the filtering magnetics 151 therein.

The magnetics 151 provide impedance matching, signal shaping and conditioning, high voltage isolation and common-mode noise reduction. This is particularly beneficial in Ethernet systems that utilize cables having unshielded twisted pair (“UTP”) transmission lines, which are more prone to noise pickup then shielded transmission lines. The magnetics help to filter out the noise and provide good signal integrity and electrical isolation. The magnetics 151 include four transformer and choke subassemblies 152 associated with each port 103. The choke is configured to present high impedance to common-mode noise but low impedance for differential-mode signals. A choke is provided for each transmit and receive channel and each choke is wired directly to the RJ-45 connector.

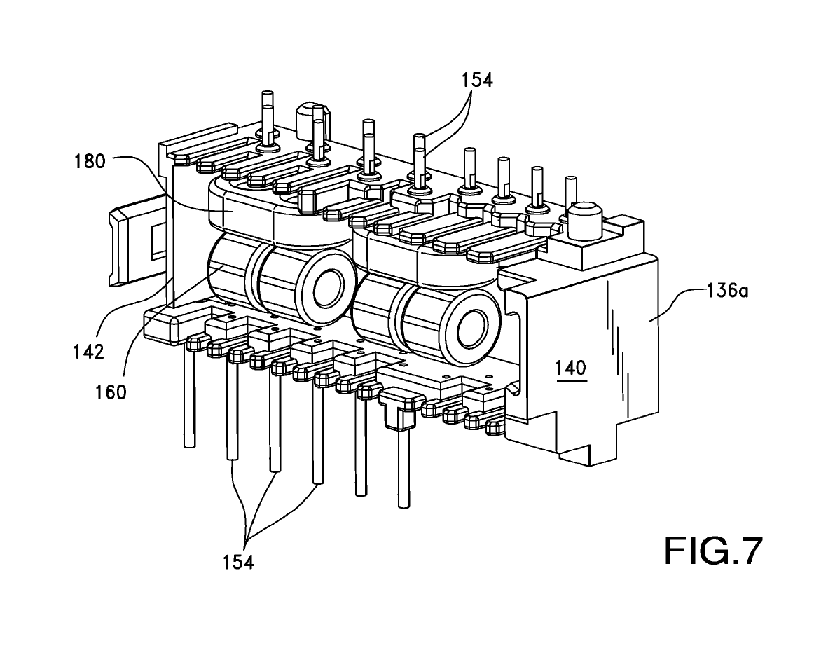

Referring now to FIGS. 5-7, after the transformer and choke subassemblies 152 are assembled as described below, the component housings 126 are assembled. Each housing 136a, 136b receives four magnetic subassemblies 152, and wire leads are connected to electrically conductive metal pins 154 such as by soldering as is known in the art. The foam shock absorbing insert 150 is placed inside one of the housing halves 136a, 136b and such insert 150 is sized such that a significant portion thereof extends out from the opening 144 of its respective housing half before the two housing halves are connected together.

During assembly of the housings halves 136a, 136b, the shock absorbing foam insert 150 compresses against the magnetics 151 so that the insert 150 is deformed to the point of filling in spaces and crevices between the various transformers and chokes. The foam insert 150 also presses the transformers and chokes against the sidewalls of the opening 144 of their respective housings to hold the magnetics in place and reduce the likelihood that a sudden or hard movement could possibly break the components or cause the windings to break.

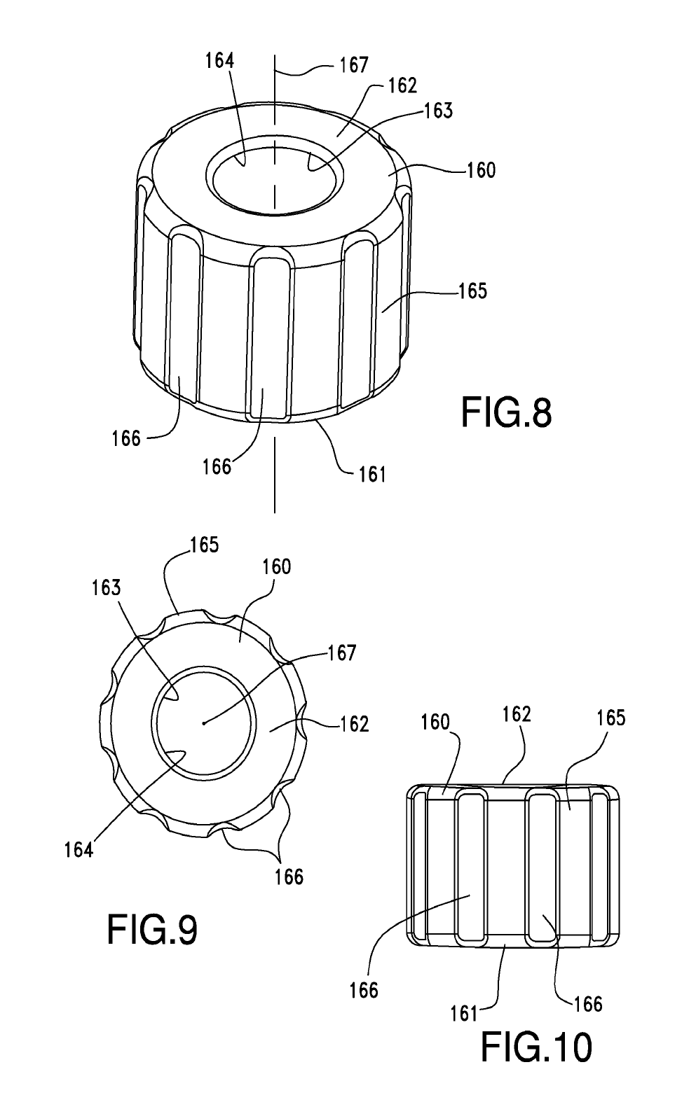

As described above, the magnetics 151 include two transformer and choke subassemblies 152 associated with each port 103 of the connector. Referring to FIG. 8, one embodiment of a magnetic subassembly 152 can be seen to include two magnetic ferrite transformer cores 160, a dual magnetic ferrite choke core 180, transformer windings 182 and choke windings 190.

A first embodiment of the transformer core 160 is depicted as a toroid or donut shape in FIGS. 8-10. Transformer toroid 160 includes substantially flat top and bottom surfaces 161 and 162, a central bore or opening 163 that defines a smooth, cylindrical inner surface 164 and an outer surface 165. Outer surface 165 is also generally cylindrical and includes a series of elongated channels or notches 166 formed therein that extend from the top surface 161 to bottom surface 162. The toroid is symmetrical about a central axis 167 except for the channels 166. A vertical cross section of the toroid 160 is generally rectangular. Channels 166 are evenly spaced apart on outer surface 165 around the central axis 167. In the embodiment shown, nine evenly spaced channels 166 are depicted so that the channels are forty degrees apart around the central axis 167. The actual number of channels is determined based upon the desired number of times twisted wires 183 are turned around toroid 160 as described below. The depth of the channels 165 is determined so that a portion of each twisted wire extends into its respective channel a sufficient depth to retain the twisted wire therein. In an embodiment, the channels 165 may have a depth sufficient to minimize any rubbing of the twisted wires when the transformer core is inserted into the respective housing. In other words, the channel may be of sufficient depth to not only restrain the winding in the desired location but also to ensure the wires do not extend beyond the outer surface (and/or top surface and/or bottom surface if the channel is so configured) so that when the transformer core is inserted the wires are protected from damage. In an embodiment, the depth of the channels may be greater than a diameter of the twisted wires. The toroid may be formed from a magnetically permeable material such as a soft ferrite or iron or by any other material with desirable magnetic properties.

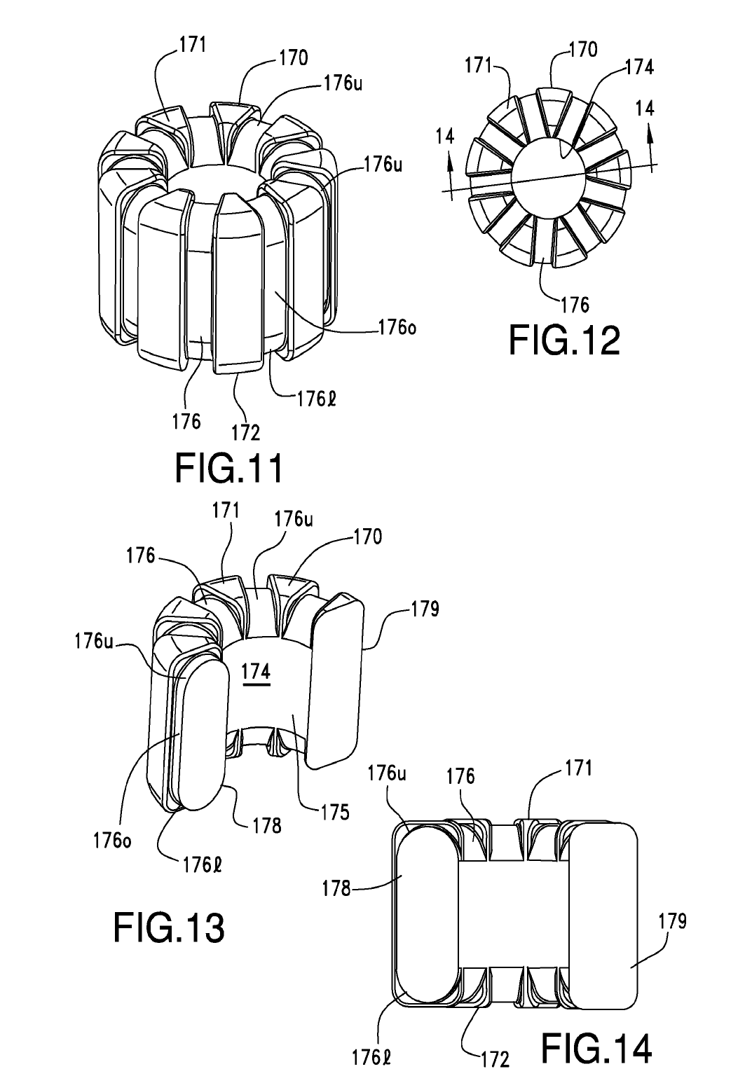

A second embodiment of the transformer toroid core 170 depicted in FIGS. 11-14 is substantially similar to transformer toroid 160 except that the channels 176 extend into and around the top surface 171 and the bottom surface 172 of toroid 170 in an arcuate manner so that a upper portion 176u of channel 176 extending through the top surface 171 and a lower portion 176l of channel 176 extending through the bottom surface 172 are arcuate or generally “C-shaped” as best seen in FIG. 13. In other words, each channel 176 includes a generally straight outer section 176o along or through the outer surface 175 and a pair of arcuate upper and lower portions 176u and 176l that extend along or through the top surface 171 and the bottom surface 172, respectively, of transformer toroid core 170. The upper and lower portions 176u and 176l of channels 176 extend from the top and bottom of outer section 176o and end at the central bore or opening 174 which defines a smooth, cylindrical inner surface 175 of toroid 170.

As best seen in FIG. 13, a vertical cross section 178 of toroid 170 taken through channel 176 is generally oval-shaped while a vertical cross section 179 of toroid 170 taken between channels 176 is generally rectangular. The C-shaped upper and lower portions 176u and 176l are desirable so that the twisted wires 183 closely follow the channel 176 as they are wrapped around toroid 170. Air gaps between the twisted wires 183 and toroid 170 can cause a loss of magnetic flux, which will tend to result in less efficient signal transfer and a resultant signal loss. Therefore, further beneficial consistency improvements are possible if the air gap can be reduced.

The dual magnetic ferrite choke core 180 is formed by sintering a magnetically permeable material such as soft ferrite or iron and includes a pair of bore or holes 181a, 181b through which the choke windings 190 are wrapped. By providing the two bores 181a, 181b, the core may support two transformer channels. If desired, the dual magnetic ferrite choke core 180 could be replaced with a pair of toroid shaped cores similar to transformer cores 160, 170. While dual magnetic ferrite choke core 180 is illustrated as having smooth surfaces about which wire 183 are wrapped and engage, channels similar to channels 166, 176 of toroids 160, 170 could be provided in dual magnetic ferrite choke core 180 in order to accurately position (and protect if the channels are deep enough) wires 183.

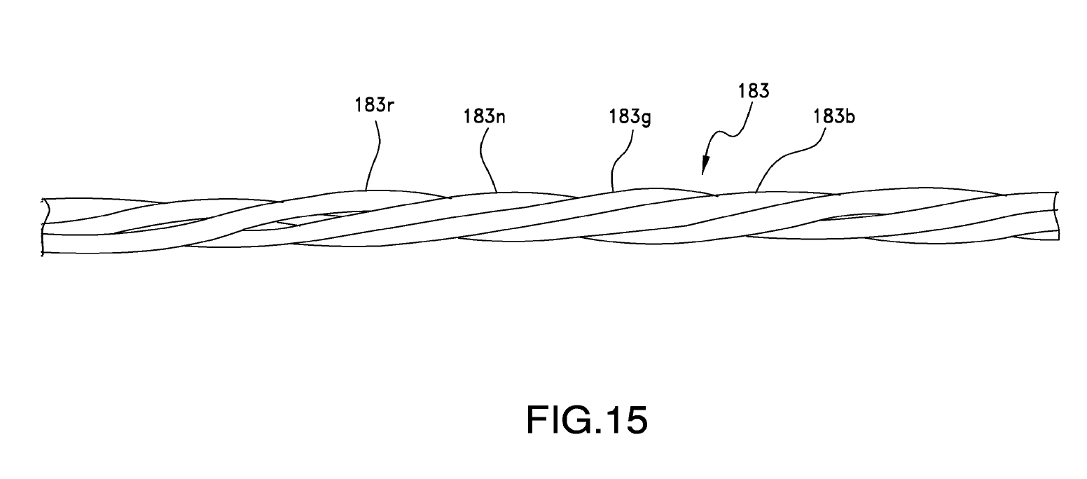

FIG. 15 illustrates a group of four wires 183 that are initially twisted together and wrapped around the transformer toroid 160. Each of the four wires is covered with a thin, color-coded insulator to aid the assembly process. As used herein, the four wires 183 are twisted together in a repeating pattern of a red wire 183r, a natural or copper-colored wire 183n, a green wire 183g, and a blue wire 183b. The number of twists per unit length (if twists are used), the diameter of the individual wires, the thickness of the insulation as well as the size and magnetic qualities of the toroids 160 and 170, the number of times the wires are wrapped around the toroids and the dielectric constant of the material surrounding the magnetics are all design factors utilized in order to establish the desired electrical performance of the system magnetics.

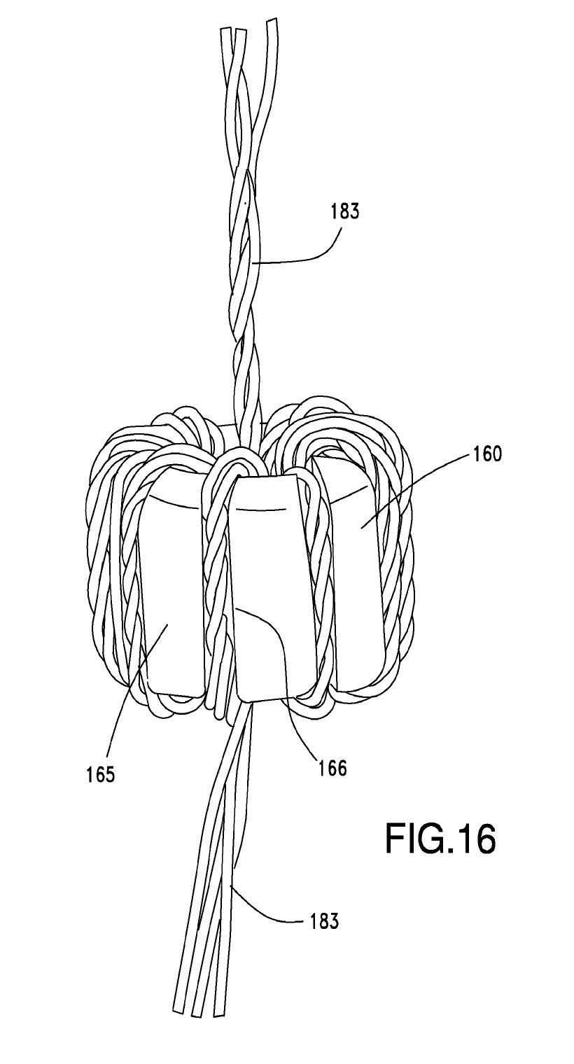

As shown in FIG. 16, the four twisted wires 183 are inserted into central bore or opening 163 of toroid 160 and are wrapped around the outer surface 164 of toroid 160 and within channel 166. The twisted wires 183 are re-threaded through central bore 163 and this process is repeated until the twisted wire group 183 has been threaded through the central bore nine times and the twisted wires positioned in eight of the nine available channels 166. As a result, the twisted wires 183 wrap around the outer surface 165 of toroid 160 eight times. Through such structure, it is possible to precisely and evenly space apart the twisted wires 182 that are located in channels 166 along the outer surface 165 of transformer toroid 160. It should be noted that the twisted wires 183 are wrapped around toroid 160 eight times even though there are nine channels 166 depicted. Depending on the desired electrical performance, it may be useful to align a portion of the windings with the remaining open channel so that nine turns are effectively created around toroid 160.

Referring to FIGS. 16-18 the twisted wires 183 exiting from opposite ends of the central bore are separated and certain of the twisted wires combined and re-twisted as is known in the art. For example, the natural colored wire 183n exiting from one end of central bore 163 is combined with the blue colored wire 183b exiting from the other end of central bore 163 and twisted together to form natural and blue choke twisted wires 183nb. Such natural and blue choke twisted wires 183nb extend into one of the bores 181a of dual magnetic ferrite choke core 180. The choke twisted wires 183nb are re-threaded through bore 181a and this process is repeated until the choke twisted wires 183nb have been threaded through bore 181 ten times and the choke twisted wires 183nb evenly spaced around bore 181a. Since the choke core 180 is of the type having two bores 181a, 181b, the choke twisted wires 183nb may not be positioned completely around the entire circumference of bore 181a. Regardless, it is desirable to maintain even spacing of the choke twisted wires. For example, if the result of inserting the choke twisted wires 183nb ten times into bore 181a is nine turns and the wires are spread out evenly over one hundred eighty degrees, the choke twisted wires 183nb will be approximately twenty two and one half degrees apart. If desired, channels similar to the channels 166 and 176 of transformer cores 160 and 170 could be formed in choke core 180 in order to accurately and securely position choke twisted wires 183nb in their desired locations.

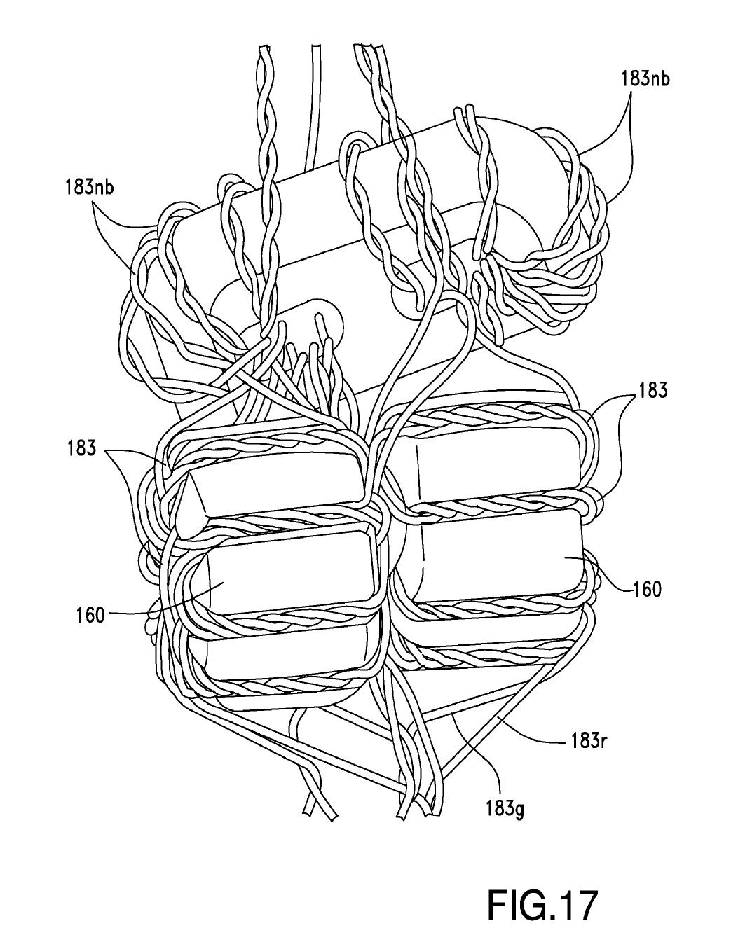

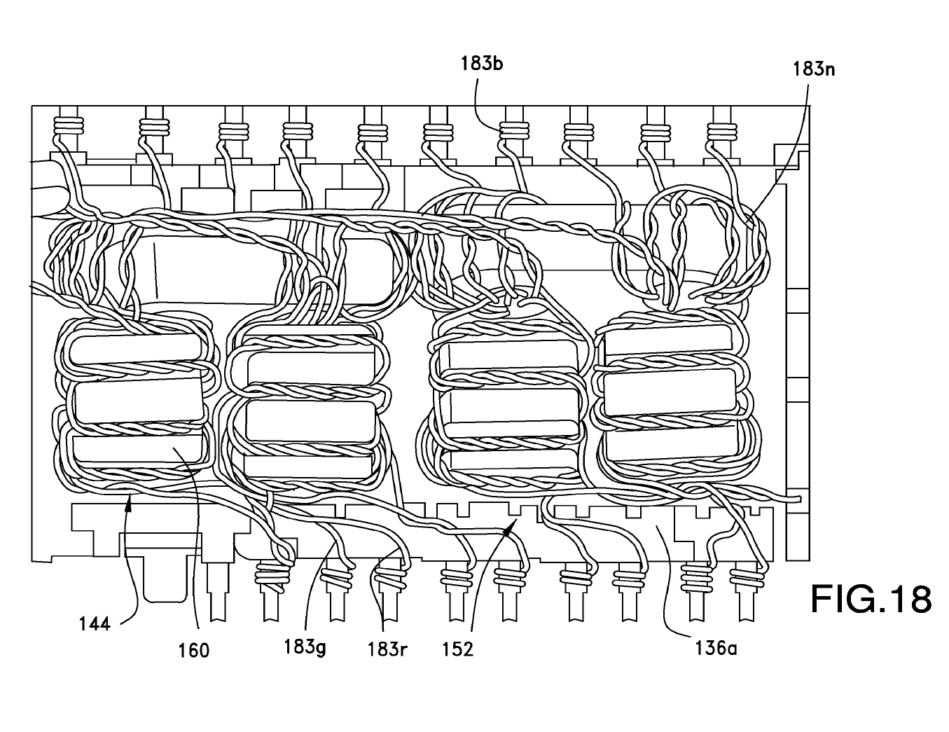

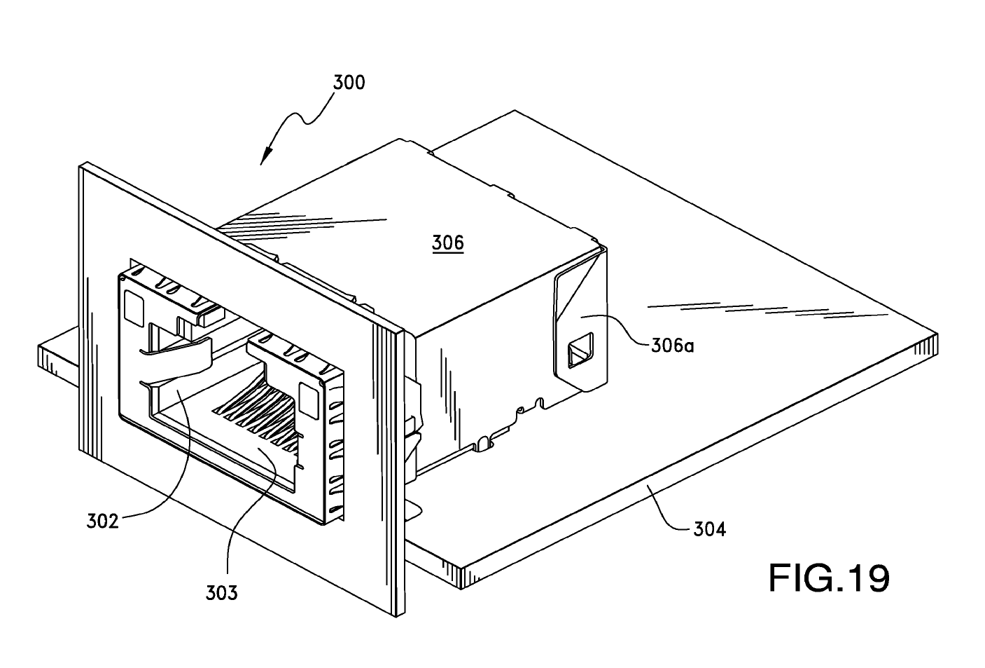

Referring to FIG. 17, a completed two transformer and choke subassembly 152 is shown. The twisted wires 183 (other than the natural wire 183n and the blue wire 183b that form the choke twisted wires 183nb) are generally grouped together such that the red wires 183r and green wires 183g extend downward while the natural wires 183n and the blue wires 183b extend upward. The two transformer and choke subassembly 152 is then inserted into receptacle 144 of housing half 136a, 136b and the wires are connected to electrically conductive metal pins 154 such as by soldering as described above. As best seen in FIG. 18, receptacle 144 is only slightly larger than two transformer and choke subassembly 152. Thus, without channels 166, 176, the transformer windings 182 are likely to be displaced from their pre-insertion, evenly spaced positions around transformer core 160. In addition, it is possible that the movement of such winding may be unnoticed because of the tight fit and corresponding limited visibility.

It should be noted that channels with relatively narrow depth will aid in the manufacture tolerances. However, the use of channels with less depth (less than the radius of the wire(s) being wound, for example) may allow the wound wire(s) to migrate slightly during installation of the magnetics. Therefore, to provide greater levels of consistency, it may be beneficial to help ensure the windings do not migrate during the manufacturing process by using channels with a depth greater than the radius of the wire(s) being wound.

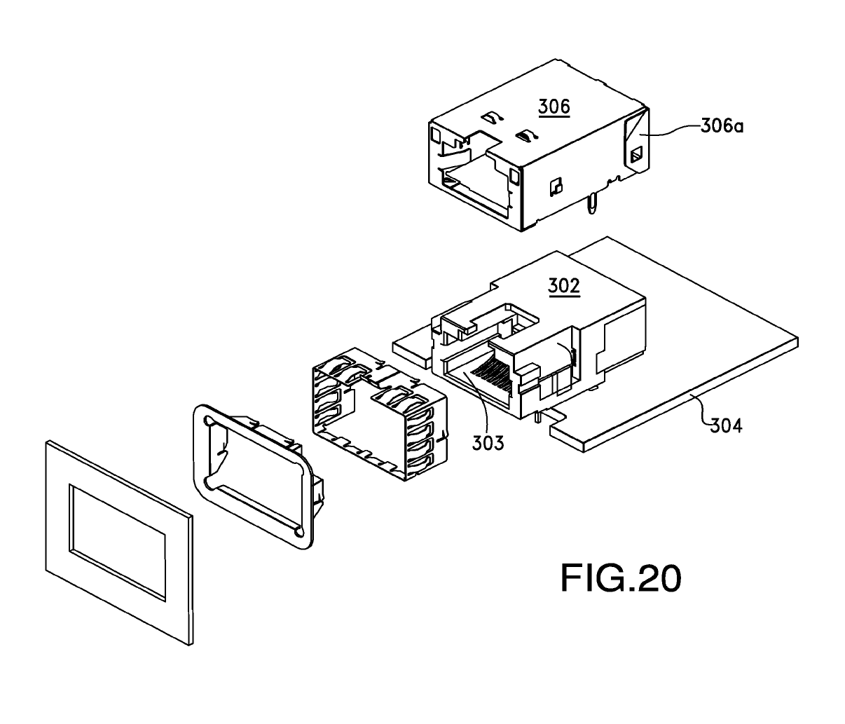

FIGS. 19-20 illustrate the front side of an alternate embodiment a modular jack. As shown, magnetic jack 300 is a single port jack for receiving multiple Ethernet or RJ-45 type of plugs (not shown). Inasmuch as many of the components of single port magnetic jack 300 are identical to those of multi-port magnetic jack 100, like numbers are used for like elements. Magnetic jack 300 includes a magnetic jack housing 302 made of an insulating material such as a synthetic resin and includes a single front side opening or port 303 that is configured to receive an Ethernet or RJ-45 type jack (not shown). The magnetic jack 300 is configured to be mounted on circuit board 304. A metal or other conductive shield assembly 306 is used to surround the magnetic jack housing 302 for RF and EMI shielding purposes as well as for providing a ground reference. Shield assembly 306 is a one piece member having a rear flap 306a that folds down over housing 302 to fully enclose and shield the housing as is known in the art.

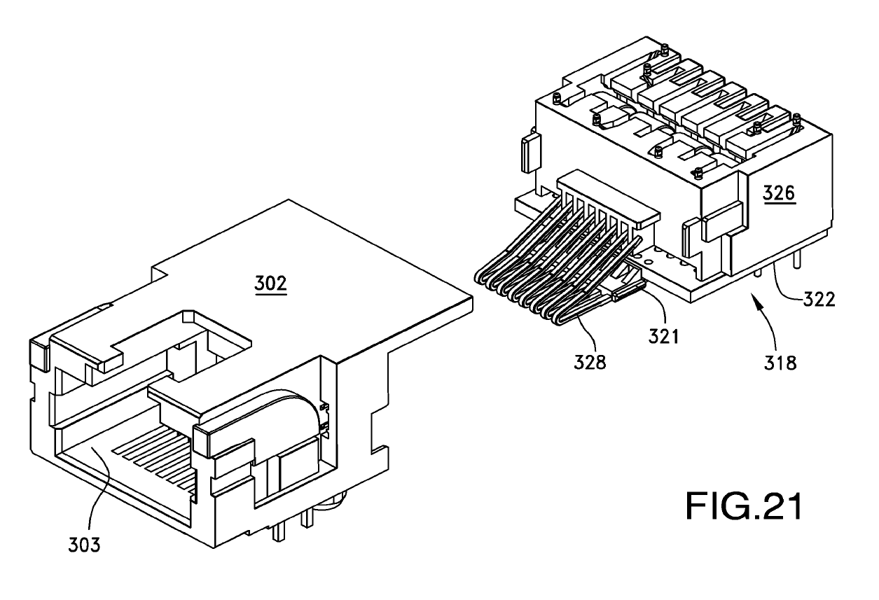

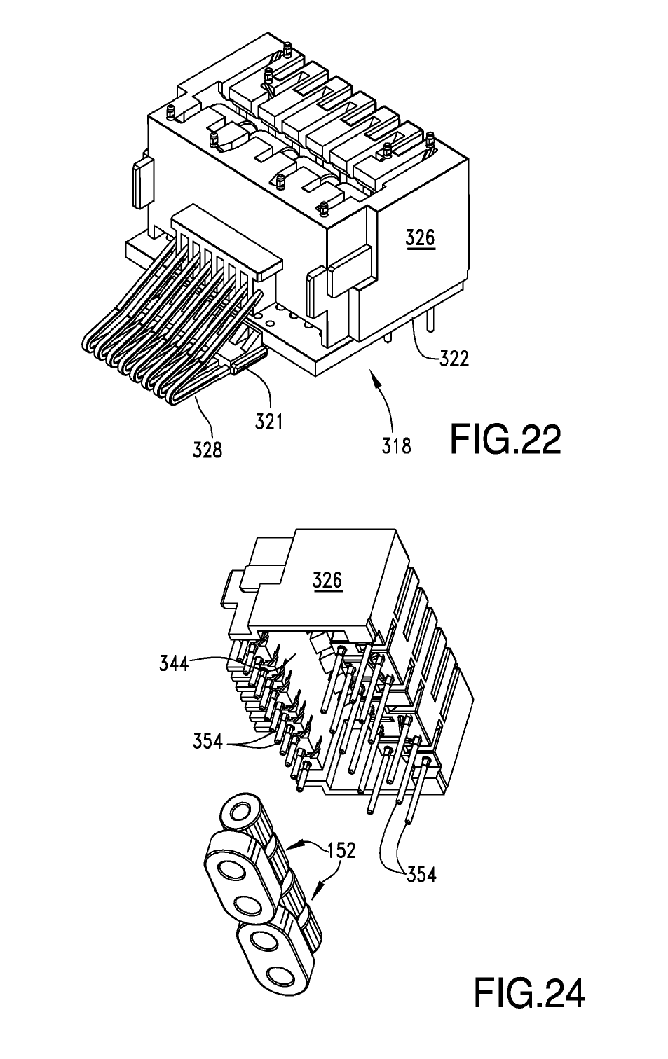

Referring to FIGS. 21 and 22, subassembly module 318 includes a contact module 320 that is electrically connected to a PCB 322. The PCB 322 is mounted to a component housing 326, which includes magnetic circuits and filtering components. The PCB 322 includes the resistors, capacitors and any other components associated with the chokes and transformers located inside the component housing 326, which together comprise the filtering circuitry of the magnetic jack. Contact assembly 321 provides physical and electrical interfaces, including contact terminals 328, for connecting to an Ethernet plug. The contact module 320 is electrically connected to the PCB 322 through leads 332, which are soldered, or electrically connected by some other means, to a row of holes 334 that are positioned along one edge 335 thereof.

Referring to FIGS. 23 and 24, component housing 326 is a one piece member for holding magnetics 151 therein. As described above, the magnetics 151 provide impedance matching, signal shaping and conditioning, high voltage isolation and common-mode noise reduction. The structure of the transformer and choke subassemblies 152 are identical to those described above and shall not be repeated. However, rather than inserting the transformer and choke subassemblies 152 into the sides of component housings 126 as described above, the transformer and choke subassemblies 152 are inserted through an opening 344 in the bottom of component housing 326. The wires 183 associated with the transformer and choke subassemblies 152 are soldered to electrically conductive metal pins 354 as described above. After the leads are soldered, epoxy may be inserted into the opening 344 if desired. Finally, the PCB 322 is mounted on the component housing 326 to complete the assembly of contact module 320 and such module may be inserted into magnetic jack housing 302.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

What is claimed is:

1. A toroidal element comprising:
a one-piece toroidal core made of a magnetically permeable material and having a central bore therein defining an inner surface, the core further including an outer surface and oppositely facing top and bottom surfaces; and
a plurality of equally spaced apart longitudinal channels formed in one of the top, bottom and outer surfaces.

2. The toroidal element of claim 1, wherein the longitudinal channels are formed in the outer surface.

3. The toroidal element of claim 2, wherein the outer surface is cylindrical.

4. The toroidal element of claim 3, wherein the longitudinal channels extend from the top surface to the bottom surface.

5. The toroidal element of claim 1, wherein the longitudinal channels are formed in at least two of the outer, top and bottom surfaces.

6. The toroidal element of claim 5, wherein the outer surface is cylindrical.

7. The toroidal element of claim 1, wherein each longitudinal channel includes an outer section formed in the outer surface, an upper section formed in the top surface and a lower section formed in the bottom surface.

8. The toroidal element of claim 7, wherein the upper and lower sections of the longitudinal channels are arcuate.

9. The toroidal element of claim 1, wherein the core is made of a sintered, ferrite material.

10. A circuit element for mounting in an electrical connector, comprising:
a toroidal circuit device having a one-piece toroidal core made of a sintered, ferrite material and having a central bore therein defining an inner surface, the toroidal core further including an outer surface and oppositely facing top and bottom surfaces, and a plurality of equally spaced apart longitudinal channels formed in one of the top, bottom and outer surfaces; and
a plurality of wires twisted together in a substantially uniform, repeating pattern to define a group of twisted wires, the group of twisted wires extending through the central bore and being wrapped around the core to define a plurality of uniformly spaced longitudinal turns with a portion of each turn being positioned in one of the channels.

11. The circuit element of claim 10, wherein the longitudinal channels are formed in the outer surface.

12. The circuit element of claim 11, wherein the outer surface is cylindrical.

13. The circuit element of claim 12, wherein the longitudinal channels extend from the top surface to the bottom surface.

14. The circuit element of claim 11, wherein the longitudinal channels are formed in more than one of the outer, top and bottom surfaces.

15. The circuit element of claim 14, wherein the outer surface is cylindrical.

16. The circuit element of claim 10, wherein each longitudinal channel includes an outer section formed in the outer surface, an upper section formed in the top surface and a lower section formed in the bottom surface.

17. The circuit element of claim 16, wherein the upper and lower sections of the longitudinal channels are arcuate.

18. The circuit element of claim 16, wherein the channels are configured so that the portion of the channel along the outer surface has a depth that is at least equal to a diameter of the plurality of wires that are twisted together.

19. The circuit element of claim 18, wherein the channels are configured so that portions of the channels on the top surface and the bottom surface have a depth at least equal to the diameter of the plurality of wires that are twisted together.

20. A modular jack comprising:
an insulative housing for receiving a mating plug, the housing having a cavity;
a plurality of terminals positioned in the housing and configured to engage contacts of the mating plug; and
a circuit element positioned in the cavity and electrically connected to the plurality of terminals, the circuit element configured, in operation, to condition signals passing through the jack, the circuit element including:
a one-piece toroidal core made of a sintered, ferrite material and having a central bore therein defining an inner surface, an outer surface and oppositely facing top and bottom surfaces;
a plurality of equally spaced apart longitudinal channels formed in one of the top, bottom and outer surfaces; and
a plurality of wires twisted together in a uniform, repeating pattern to define a group of twisted wires, the group of twisted wires extending through the central bore and being wrapped around the core to define a plurality of uniformly spaced longitudinal turns with a portion of each turn being positioned in one of the channels.
